(19) United States
(12) Patent Application Publication
(10) Pub. No.: US 2024/0304053 A1
(43) Pub. Date: Sep. 12, 2024

(54) Multipurpose Vending Machine and System for Dispensing Cannabis Related Products

(71) Applicant: Richtresha Dorris, Champaign, IL (US)

(72) Inventor: Richtresha Dorris, Champaign, IL (US)

(21) Appl. No.: 18/503,289

(22) Filed: Nov. 7, 2023

Related U.S. Application Data
(60) Provisional application No. 63/450,995, filed on Mar. 9, 2023.

(51) Int. Cl. G07F 11/62; G06K 7/14; G06Q 20/40

(52) U.S. Cl. CPC G07F 11/62; G06K 7/1413; G06Q 20/401

(57) ABSTRACT

The present invention relates to a legalized cannabis and related products vending machine and system. The vending machine is configured to dispense legalized cannabis and other products to authorized users. The authorization is done by scanning a received identification document for age or other permissions from a user and determining if the age is more than a predetermined age or if the permissions are valid. The machine stores cannabis and other products in trays and images of the stored items are displayed on a touch display. The machine is configured to receive payment for processing a transaction. In the back end, the machine is connected to a server and one or more of an authority server and medical department server.

### CROSS-REFERENCE TO RELATED APPLICATION

The present application claims priority to, and the benefit of, U.S. Provisional Application No. 63/450,995, which was filed on Mar. 9, 2023 and is incorporated herein by reference in its entirety.

### FIELD OF THE INVENTION

The present invention relates generally to the field of commercial vending and dispensing machines. More specifically, the present invention relates to a vending or dispensing machine capable of selling legal cannabis-related products. The machine offers a way for people to easily access and secure legalized cannabis products. More specifically, the machine includes a secure payment and identification verification system to ensure only authorized individuals can purchase products from the machine. Accordingly, the present disclosure makes specific reference thereto. Nonetheless, it is to be appreciated that aspects of the present invention are also equally applicable to other like applications, devices and methods of manufacture.

### BACKGROUND

By way of background, a number of U.S. states and the District of Columbia have legalized medical marijuana for medical treatments and other states have legalized marijuana for recreational use. Medical marijuana uses the marijuana plant or chemicals in the plant to treat diseases or conditions. The recreational marijuana and the medical marijuana are essentially the same. In fact, the marijuana plant contains more than 100 different chemicals called cannabinoids.

With increasing acceptance of cannabis for both medical and recreational purposes, people look to purchase cannabis from convenient locations. The retail stores and pharmacies providing the cannabis often have long queues due to verification processes which can frustrate a user in getting cannabis related products for their use. Further, in times of pandemics such as COVID 19, people avoid going in crowded places such as stores and thus end up not getting medical and recreational cannabis. Particularly, people in remote areas face difficulty in accessing medical cannabis as the dispensaries and stores providing such cannabis products are not located in such remote areas.

Another problem arises as many pharmacies and stores are only open or staffed during certain hours of the day or days of the week. Given the current review and verification procedures, a large segment of the population may not be able to purchase cannabis. Also, manual verification of the identity of an individual seeking to purchase the product by a pharmacist or store manager is not tamper proof and there have been cases where underage and other unauthorized people have received marijuana products.

Therefore, there exists a long felt need in the art for a turn-key solution that enables people to get cannabis related products at any time as per their requirements or preferences. There is also a long felt need in the art for a device and method that solves the problem of people standing in long queues for purchasing cannabis related products. Additionally, there is a long felt need in the art for a way for people living in remote areas to purchase cannabis related products. Moreover, there is a long felt need in the art for a device that can automatically dispense cannabis related products after receiving a verified identity of a user. Further, there is a long felt need in the art for a device that can save time for the pharmacist to verify the details of users for providing cannabis related products. Finally, there is a long felt need in the art for system that offers a way for people to easily access legalized cannabis products at convenient locations and hours of the day.

The subject matter disclosed and claimed herein, in one embodiment thereof, comprises a multipurpose legalized cannabis products vending or dispensing machine. The legalized cannabis products vending machine features a plurality of trays or bins for storing cannabis related products and other edible products, a touch screen display for displaying the stored and available cannabis related products and edible products. The touch screen display is configured for receiving a selection of products to purchase by the user. The machine further has an identity document slot for receiving one or more identity documents for verification of age of the user, a card slot for receiving one or more payment cards for payment of the selected items, an electronic camera for capturing video of a user operating the machine, an LED light indicating the working status of the machine, a speaker for playing out an audio message indicating that the machine has been tampered with and a dispenser tray for receiving selected items from the trays on successful verification and processing of one or more of the identity documents and one or more payment cards.

In this manner, the cannabis related products vending or dispensing machine of the present invention accomplishes all of the forgoing objectives and provides users with an improved vending or dispensing machine that can be installed anywhere and is capable of selling legal cannabis-related products. The machine includes a secure payment and identification verification system to ensure only authorized individuals can purchase products from the machine without standing in long queues or traveling to authorized dispensaries. The machine provides instant and convenient access to the cannabis related products and eliminates long waits in queues. The machine reduces wait times and limits social contact. The machine increases the availability of legal cannabis products in remote areas and provides quick, easy, convenient and secure payment and smooth identity verification.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a multipurpose legalized cannabis products vending or dispensing machine. The legalized cannabis products vending or dispensing machine includes a first storage area having a plurality of trays of bins for storing cannabis related products. A second storage area having a plurality of trays or bins for storing other edible products or accessories. A touch screen display for displaying the stored cannabis, products, related products and edible products, and the touch screen display is configured for receiving a selection of products to purchase by the user. An identity document slot for receiving one or more identity documents for verification of age of the user or other license or permission. A card slot for receiving one or more payment cards, such as credit, prepaid cards, debit cards or a combination thereof for payment of the selected items. An electronic camera for capturing video or still images of a user operating the machine, and an LED light for indicating the working status of the machine. A speaker for playing an audio message or alert indicating that the machine has been tampered with, and a dispenser tray for receiving selected items from the trays or bins on successful verification and processing of the one or more identity documents and one or more payment cards.

In yet another embodiment of the present invention, a method of permitting only authorized users to use a legalized cannabis products vending or dispensing machine is disclosed. The method comprising the steps of providing the vending machine and having a plurality of trays or bins for storing legalized cannabis products, related products and refrigerated products, such as edible items that may be perishable. A dispensing actuator for dispensing stored products from the trays or bins, and a display processor for displaying images of stored items and for receiving a selection of the stored items. The vending or dispensing machine includes an identity scanner for reading age data from an identification card and then reading the age data or other permissions from the identification card inserted into a slot in the vending or dispensing machine by a potential user. Reading or scanning payment information from a payment card inserted into another slot in the vending or dispensing machine by the potential purchaser. Verifying the age, data and other permissions to indicate that the potential user is older than a predetermined minimum age, or is otherwise permitted to make the purchases and dispending one or more age or permission restricted cannabis related products from selected items for the potential user.

In yet another embodiment, a cannabis related product dispensing or vending system for permitting only authorized users to access a legalized cannabis products vending or dispensing machine is disclosed. The system includes at least one cannabis product vending machine, which is connected to a central server communicatively coupled to the vending machine through a network. The vending machine uses a communication interface coupling. The vending or dispensing machine is further coupled to a state or other dispensing authority server which contains a database for transmitting identification information of a potential user and coupled to a medical department server for verifying doctor or prescription information on a medical card inserted into the vending machine by the user. The vending machine dispenses one or more age or otherwise permission restricted cannabis related products only after successful verification of the age or eligible permissions from the licensed doctor, or other governmental or administrative server or database.

In yet another embodiment, the machine locally compares the age or other permissions of the potential user by comparing the age and permission information read from an identification document with a predetermined age or group of permissions.

In yet another embodiment, the machine has a medical card scanner for scanning a received medical card, and an identity scanner for detecting an identification number, permission sequence or other data or information concerning the ability of the user to make a purchase.

In yet another embodiment, a vending or dispensing machine is disclosed. The vending or dispensing machine is configured to permit only authorized users to use the vending or dispensing machine for dispensing an age or other restricted product. The vending or dispensing machine is configured to read age and other permission information from an identification or other government issued card and read payment information from a payment card, such as a credit or debit card. A microprocessor in the vending machine compares the age or other permissions on the identification card with a predetermined age or permissions list. If the age or permissions on the identification card is more than the predetermined age, or the permissions fall within a certain category, then the customer is construed to be old enough or to have the sufficient permissions to purchase a regulated product or accessory, the vending or dispensing machine is enabled and a regulated product can be sold and dispensed from the vending machine or dispensing apparatus.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a cannabis vending machine or other dispensing apparatus of the present invention in accordance with the disclosed architecture;

FIG. 2 illustrates a schematic view showing a cannabis vending machine or dispensing apparatus network system in accordance with the disclosed architecture;

FIG. 3 illustrates a block diagram of the internal electronic components essential for operation of one potential embodiment of the vending machine or dispensing apparatus of the present invention in accordance with the disclosed architecture;

FIG. 4 illustrates a schematic view showing the wireless connection of one potential embodiment of the multipurpose vending machine or dispensing apparatus of the present invention with a smartphone application installed in an electronic device in accordance with the disclosed architecture; and

FIG. 5 illustrates a flow diagram showing exemplary steps performed by one potential embodiment of the cannabis related products vending machine or dispensing apparatus of the present invention in dispensing one or more products in accordance with the disclosed description.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a turn-key solution that enables people to obtain cannabis related products at any time as per their preferences, prescriptions or other needs. There is also a long felt need in the art for a device and method that solves the problem of people standing in queues or having to travel to inconvenient locations for purchasing cannabis and related products. Additionally, there is a long felt need in the art for a way for people living in remote areas for purchasing cannabis and related products. Moreover, there is a long felt need in the art for a device that can automatically dispense cannabis and related products on a verified basis once the identity of a user is confirmed. Further, there is a long felt need in the art for a device or system that can save time of pharmacist or other individual licensed to dispense cannabis and related products to verify details of the prospective purchasers for dispensing cannabis and related products. Finally, there is a long felt need in the art for system that offers a way for people to easily access legalized cannabis and related products.

The present invention, in one exemplary embodiment, is a novel vending machine or other dispensing apparatus for permitting only authorized users to use the vending machine or other dispensing apparatus for dispensing an age or other permission restricted medical and recreational cannabis product. The vending machine or other dispensing apparatus is configured to read age or verify other permission information from an identification card and read payment information from a payment card or other government issued card. A microprocessor in the vending machine or other dispensing apparatus compares the age or other permissions on the identification card with a predetermined age or group of permissions. If the age or other permissions on the identification card is more than the predetermined age or the permissions include the ability to have the particular product, the customer is construed to be old enough or have sufficient permissions to purchase a regulated product, the vending machine or other dispensing apparatus is enabled and a regulated product can be sold and dispensed from the vending machine or other dispensing apparatus.

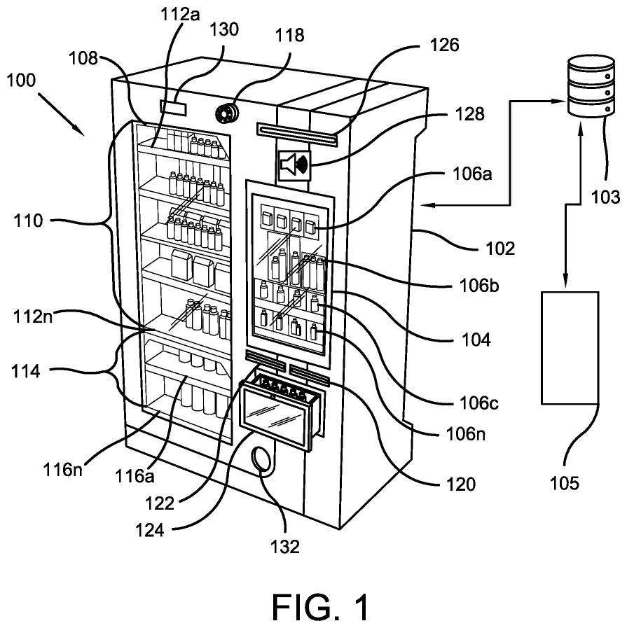

Referring initially to the drawings, FIG. 1 illustrates a perspective view of one potential embodiment of a cannabis vending machine or other dispensing apparatus 100 of the present invention in accordance with the disclosed specification. The cannabis vending machine or other dispensing apparatus 100 of the present invention is designed for dispensing individual containers or packages of legal cannabis-related products, kits of edible THC products and other refrigerated and non-refrigerated products. The vending machine or other dispensing apparatus 100 also includes a secure payment and identification verification system to ensure only authorized individuals can purchase products from the machine or apparatus. The vending machine or other dispensing apparatus 100 is freestanding and can be positioned at any location, such as on a sidewalk, pharmacy, shopping complexes or within a store for providing a safe and reliable method for an individual to conveniently purchase a desired quantity of a medical or herbal substance in an easy and efficient way.

More specifically, the cannabis vending machine or other dispensing apparatus 100 has a housing 102 made from a durable material such as a metal, alloy, heavy-duty plastic or the like. The machine or apparatus 100 has a touch display 104 for displaying images or text (referenced through numerals 106a-n) of available cannabis and other products and receiving a user input of selection of one or more cannabis and other products. The housing 102 has a transparent face panel 108 that allows a user to view the stored or available items in the vending machine 100. The machine 100 has an upper storage section 110 having a plurality of trays 112a-n for storing and dispensing cannabis related products and a lower storage section 114 having a plurality of trays 116a-n for storing and dispensing refrigerated products. The vending machine 100 is also connected to a database 103 which maintains inventory levels. The database 103 may be located at a remote location. In addition, the database can also be used to send direct mail correspondence to the user that made a purchase to allow the owner of the vending machine to sell refills and other products to the user. In addition, the database 103 can be used to send out of stock products to the user in the event the inventory is depleted. The database 103 may also be connected to other vending machines 105 to determine availability of products at other locations and to manage inventory.

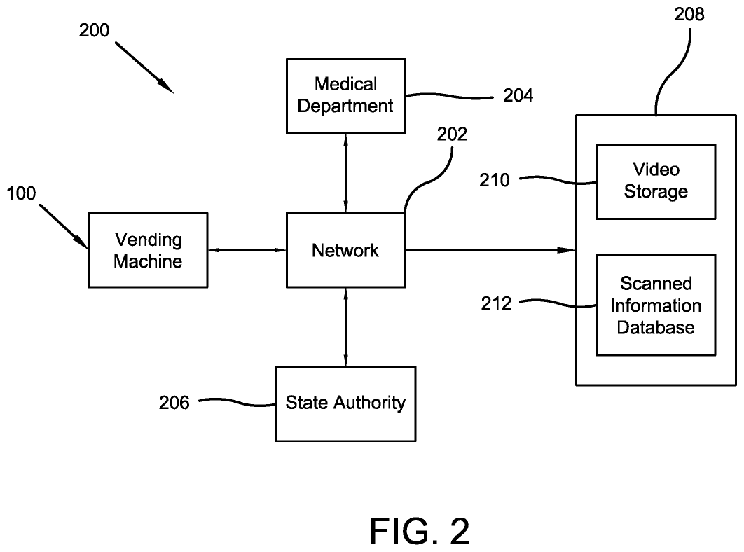

The vending machine or other dispensing apparatus 100 has an electronic camera 118 focusing on front of the machine 100 for recording video or capturing still images of the operation of the machine 100 by a user, as well as other activity that may be occurring near the machine, such as an attempted theft. The recorded video or still images are transmitted in a real time to a central server as best shown in FIG. 2. The machine 100 has a card slot 120 for receiving a payment card, such as a credit card, prepaid card, debit card or the like for purchasing one or more products from the machine 100. The card slot 120 has an embedded card verifier for verifying card details inserted into the slot 120 before facilitating a transaction. An identity document slot 122 is provided on the machine 100 for receiving and scanning a legal identity document such as a driver's license or other government issued card and is used for ascertaining age or other permissions of the user. The scanned document is also uploaded to the central server for a recording mechanism. The machine 100 allows a user to choose one or more items for dispensing once the age or other permissions of the user is ascertained to be above the legal age or within an approved set for receiving the product.

An advantage of the vending machine or other dispensing apparatus 100 is that the identity document slot 122 can also be used for receiving a medical prescription, government issued card or medical card from a user. The card is scanned or read by the machine 100 and the available cannabis and TSH products which are approved for the particular individual are displayed on the display 104 before dispensing. The scanned prescription should be a legal prescription from a licensed medical doctor or approved individual. A dispenser tray 124 is positioned below the slots 120, 122 into which the ordered items fall from the trays or bins of the machine 100. The tray 124 can be pulled forward by a user for accessing the items. An LED 126 is configured to illuminate in a specific color to indicate the working status of the machine 100. The LED 126 may illuminate in green color indicating tamper proof working of the machine 100 and may illuminate in red color indicating that the machine 100 has been tampered with. The voice alarm 128 is also disposed on the housing 102 to alert people about tampering with the machine. The machine is also able to alter the police in the event of attempted tampering as well as the owner of the machine.

The machine 100 is designed to connect to a network (as shown in FIG. 2) to communicate with a central or distribution server using the communication interface 130. The communication interface 130 may include one or more wired or wireless interfaces, such as an 802.11 wireless network interface, an Ethernet interface, an Ethernet over powerline interface, a BLUETOOTH® interface, a near-field wireless communication interface, a Public Switched Telephone Network (PSTN) interface or any other suitable communication interface.

The storage areas 110, 114 storing various items are accessed for replenishing the inventory of the machine 100 through the inventory access port 132. More specifically, the transparent frame or front panel 108 is unlocked using the inventory access port 132 to access the storage areas 110, 114 for replenishing or updating the inventory and product mix. The system will track the dispensing of products so that when the inventory is replenished the more popular items can be increased and other items which are not being sold can be removed.

FIG. 2 illustrates a schematic view of a cannabis vending machine or other dispensing apparatus network system 200 in accordance with the disclosed specification. As shown, the vending machine or other dispensing apparatus 100 is coupled to a central server 208 through a network 202 for transmitting order information, captured video and other information. The network 202 may include a local area network, a public network (e.g., the internet), or any other suitable wired or wireless communication network. The machine 100 can also be connected to a plurality of other vending machines or other dispensing apparatus 100 through the network 200 allowing one machine or apparatus to indicate to a potential purchase when an out of stock situation exists, where the nearest machine having the available product is located.

The server 208 can also be used for processing and verifying the order status of one or more ordered products. It should be noted that the processing may also be done locally within the vending machine or other dispensing apparatus 100. Additionally, the server 208 is used for storing the user information scanned from the legal identity document in an encrypted form in the scanned information database 212. As stated, the user information is captured by the identity scanner 122 as described in FIG. 1 and is transmitted in an encrypted form through the network 202.

The server 208 has a video or image storage memory 210 that stores the video or images captured by the camera 118 of the machine 100. The camera 118 continuously transmits the recorded video or images of a user ordering and receiving items from the machine 100 and the video or images are stored in the video storage memory 210.

For verification of the legal identity documents submitted by a user to the vending machine 100, the machine 100 is connected to a state authority or other administrative or dispensing authority server 206. The legal identity document information is transmitted to the state or administrate or dispensing authority server 206 for verification of the age or other permissions of the user through the network 202. On a successful verification, the user may be notified by providing an alert using the speaker disposed on the machine 100, or the LED indicator 126.

For verification of the medical card or a prescription submitted by the user, the machine or other dispensing apparatus 100 is connected to a central medical department server 204. The medical card or prescription information is transmitted to the server 204 for verification of the legality of the doctor or other individual of whose prescription is submitted for verification. On a successful verification, the user may be notified by providing an alert using the speaker disposed on the machine 100 or LED indicator 126.

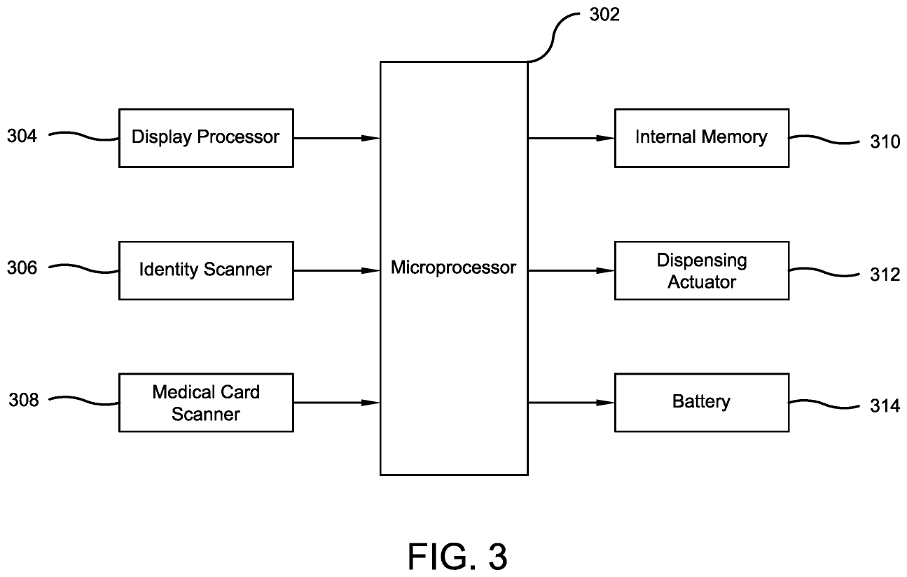

FIG. 3 illustrates a block diagram showing exemplary internal electronic components for working of the vending machine or other dispensing apparatus 100 in accordance with the disclosed specification. The block diagram illustrated in FIG. 3 displays the exemplary electronic components housed within the machine 100 and it should be understood that all the electronic components are connected to each other through one or more wired or wireless circuits (not shown). Also, any number of additional components may be added to enhance the functionality of the machine 100. More specifically, the machine 100 has a microprocessor 302 that is used for controlling operations of the machine 100. The microprocessor 302 receives signals from electronic components and accordingly actuates an appropriate action. As shown, the machine 100 has a display processor 304 for displaying images of available inventory of the machine 100 along with quantity and prices on the display 104. Further, the display processor 304 can be configured remotely in the form of updates by the central server 208. The microprocessor 302 in the vending machine is also configured to compare the age and other permissions on the identification or other government or administrative card with a predetermined age or group of permissions. If the age or group of permissions scanned or read from the identification card is more than the predetermined age or the appropriate permissions are validated, a customer is construed to be old enough or to have permission to purchase a regulated product.

An identity scanner 306 is configured to read identity information from an identification or other card inserted in the slot 122 in order to identify age or permissions of the user and store identity information as well as purchase information of the user. The identity scanner 306 can be a commercially available optical scanner capable of scanning barcodes, for example. A separate medical card or prescription scanner 308 is configured to scan a medical card or prescription inserted through the slot 122 of the machine 100.

An internal memory 310 is configured to store an identifier of the machine 100 and also captured video or images of the last half an hour for emergency purposes. The internal memory 310 can include volatile memory and nonvolatile memory. By way of illustration, and not limitation, nonvolatile memory can include read only memory (ROM), programmable ROM (PROM), electrically programmable ROM (EPROM), electrically erasable programmable ROM (EEPROM), flash memory or nonvolatile random-access memory (RAM) (e.g., ferro-electric RAM (FeRAM). Volatile memory can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM) and enhanced SDRAM (ESDRAM).

The microprocessor 302 is configured to actuate the dispensing actuator 312 on successful processing of identity, prescription, permissions and payment by a user to dispense one or more cannabis and other items into the dispenser tray. The machine 100 has a built-in battery 31 for providing power to the machine 100 for operation in the event power is not available to the machine.

As it is employed in the subject specification, the term “microprocessor” 302 can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units.

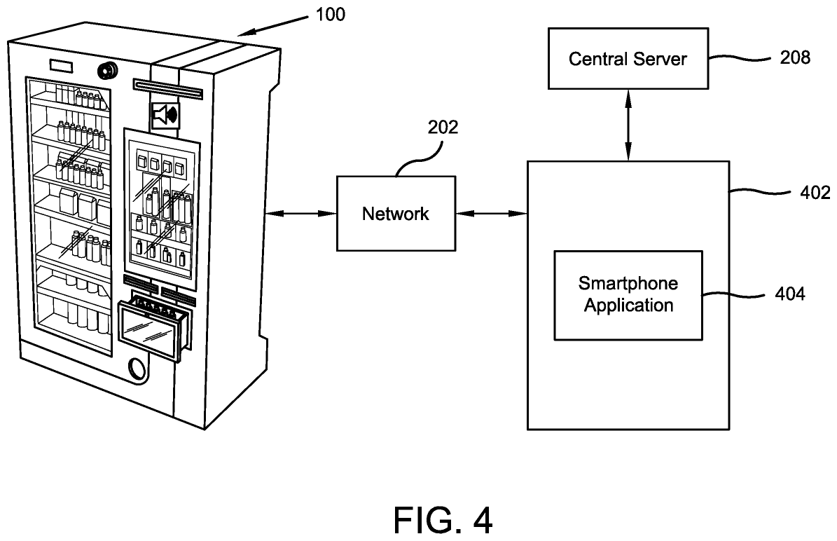

FIG. 4 illustrates a schematic view showing connection of the multipurpose vending machine or other dispensing apparatus 100 with a smartphone application 404 installed in an electronic device 402 in accordance with the disclosed specification for a user to purchase cannabis and other products from the vending machine or other dispensing apparatus 100. The present invention provides a computer implemented smartphone application 404 configured to be installed in the electronic device 402. A user can create a profile in the smartphone application 404 by uploading the identity document and optionally the payment details in the smartphone application 404. Once, the identity document is verified for a legal age, or other permissions, the user can select the vending machine or other dispensing apparatus 100 from the user interface of the application 404 for purchasing cannabis and other related products from the vending machine 100. The user may also select the vending machine via the smartphone application which is in the closest proximity to the user prior to driving to the specific machine. In addition, the smartphone may also inform the user of the available products at a particular location which may then alter the travel plans of the user.

In use, the vending machine or other dispensing apparatus 100 can be searched using a particular parameter such as location or machine identifier in the smartphone application 404. The smartphone application 404 is configured to display the available items in the vending machine 100 that can be purchased by the user using the smartphone application 404. Once a successful payment is completed on the application 404, the identity document can be inserted into the slot 122 of the machine and the ordered products are automatically dispensed by the machine. This allows a user to order products on the application 404 and pick the products from the selected vending machine or other dispensing apparatus 100. This further saves time of the user and enables the user to order when physically away from the machine 100.

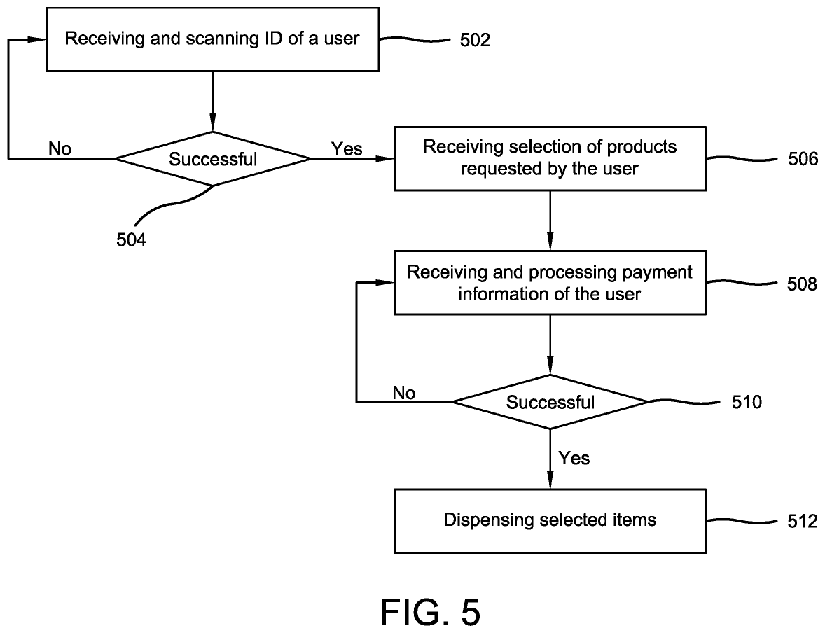

FIG. 5 illustrates a flow diagram showing exemplary steps performed by the cannabis related products vending machine or other dispensing apparatus 100 of the present invention in dispensing one or more products in accordance with the disclosed specification. As shown, initially an identification document is received from the document slot and scanned by the machine (Step 502). Then, it is determined if the age verification or other permission verification is successful and is legal or authorized (Step 504). If the determination is successful, then the process flows to the step 506 where the machine receives the selection of one or more cannabis or related products, edible products from the display screen of the machine. If the determination is unsuccessful, then the process moves back to step 502. After receiving the selection of products, the machine 100 receives and processes payment information submitted by the user (Step 508). The payment information can be scanned from the credit card, debit card or currency submitted by the user. Then, it is determined if the verification of the payment information is successful or not. If it is determined that the payment is successfully verified, then the selected or ordered items are dispensed by the machine (Step 512). Otherwise, the customer is prompted to again enter the payment details.

It should be appreciated that the machine 100 can be used as a standalone device or can be connected to a network. Further, the machine comes in various dimensions to fit for various applications. The present invention vending machine ensures that only authorized persons can purchase products from the vending machine or other dispensing apparatus. As such, cannabis related products can be sold through vending machines without the fear of use from underage or otherwise unauthorized persons.

Additionally, it is contemplated that the user will be required to remove their mask or any facial covering prior to completing a purchase from the vending machine 100. Also, it is contemplated that the vending machine will further comprise backup power and security systems in the event of a blackout or power outage.

Furthermore, the described features, operations or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps, or by a combination of hardware, software and/or firmware.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cannabis products vending machine”, “cannabis vending machine”, “vending machine”, “machine”, “cannabis related and other edible products vending machine” and “multipurpose vending machine” are interchangeable and refer to the cannabis related and other edible products vending machine 100 of the present invention.

Notwithstanding the forgoing, the cannabis related and other edible products vending machine 100 of the present invention can be of any suitable size and configuration as is known in the art without affecting the overall concept of the invention, provided that it accomplishes the above-stated objectives. One of ordinary skill in the art will appreciate that the size, configuration and material of the cannabis related and other edible products vending machine 100 as shown in the FIGS. are for illustrative purposes only, and that many other sizes and shapes of the cannabis related and other edible products vending machine 100 are well within the scope of the present disclosure. Although the dimensions of the cannabis related and other edible products vending machine 100 are important design parameters for user convenience, the cannabis related and other edible products vending machine 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A vending machine for dispensing a plurality of cannabis related products, the vending machine comprising:
a housing having a transparent front panel and comprising a number of racks or bins for holding the plurality of cannabis related products;
a touch display for selecting at least one of the plurality of cannabis related products;
a payment slot for receiving a payment from a user; and
a validation slot for confirmation of the user to purchase the at least one of the plurality of cannabis related products.

2. The vending machine as recited in claim 1, wherein the payment may be one of a cash, a credit card, a debit card, a pre-paid card or a combination thereof.

3. The vending machine as recited in claim 1 further comprising a refrigeration area provided in a lower portion of the housing.

4. The vending machine as recited in claim 1 further comprising a camera for capturing at least one of a video or a still of activity around the housing or of the user of the vending machine.

5. The vending machine as recited in claim 1 further comprising a LED light and a speaker.

6. The vending machine as recited in claim 5, wherein the LED light indicates an operational status of the vending machine, and the speaker provides a message.

7. The vending machine as recited in claim 1, wherein the vending machine is connected to a network for providing a verification and a processing of the payment.

8. The vending machine as recited in claim 7, wherein the network is connected to a database and a plurality of other vending machines to maintain an inventory and determine a product availability.

9. The vending machine as recited in claim 1 further comprising a communication interface allowing the user to communicate with others serving the vending machine.

10. The vending machine as recited in claim 1 further comprising a display for displaying the plurality of cannabis products in the vending machine.

11. The vending machine as recited in claim 1 further comprising an upper storage area and a lower storage area.

12. A vending system for dispensing a plurality of cannabis and related products, the vending system comprising:
a vending machine having a housing containing the plurality of cannabis and related products;
a display for displaying the plurality of cannabis and related products;
a touch screen for ordering at least one of the plurality of cannabis and related products;
a validation slot for receiving validation information;
a network connected to the vending machine;
a database connected to the network; and
a dispensing authority connected to the network for approving a release of one of the plurality of cannabis and related products.

13. The vending systems as recited in claim 12, wherein the dispensing authority is a state authority, a medical authority or a pharmaceutical authority.

14. The vending systems as recited in claim 12, wherein the database contains information obtained from a user of the vending system.

15. The vending systems as recited in claim 12 further comprising a camera for capturing a video or an image of a user of the vending system.

16. The vending systems as recited in claim 12 further comprising a verification slot and a payment slot for receiving a payment.

17. The vending systems as recited in claim 12 further comprising a microprocessor, a memory and a battery.

18. The vending systems as recited in claim 12 further comprising a smartphone having a software application stored thereon for interfacing with the vending system.

19. A method of using a vending system comprising the steps of:
providing a vending machine having a plurality of cannabis and related products;
receiving an ID card from a potential user;
scanning the ID card;
determining whether the ID card is valid;
receiving a selection of a product from the plurality of cannabis and related products from the potential user;
obtaining payment information from the potential user; and
dispensing the product to the potential user after payment.

20. The method of using a vending system as recited in claim 19 further comprising a network connected to the vending machine.
